(19) United States
(12) Patent Application Publication
(10) Pub. No.: US 2026/0334717 A1
(43) Pub. Date: Oct. 29, 2026

(54) TAMPING DEVICE FOR COFFEE MACHINE

(71) Applicant: Shenzhen Sun Cupid Dian Qi Co. Ltd., Shenzhen (CN)

(72) Inventors: Kaifeng LUO, Shenzhen (CN); Shiwei Ye, Shenzhen (CN); Hai Liu, Shenzhen (CN)

(21) Appl. No.: 19/188,005

(22) Filed: Apr. 24, 2025

(51) Int. Cl. A47J 31/44; A47J 31/42

(52) U.S. Cl. CPC A47J 31/446; A47J 31/42

(57) ABSTRACT

A tamping device for a coffee machine includes a tamping handle, a tamping handle connecting block, a screw cap, a pressing wheel, a driven wheel, a plurality of planetary gears, a gear ring, a gear ring cover, a driving screw rod, a pressing ring, a tamping sleeve, a tamping sleeve seat, a tamping plate and a tamping sleeve housing. The tamping handle is installed on a shaft of the pressing wheel. The pressing wheel, the springs, the spring cover, and the driven wheel are assembled together. The ring gear, the plurality of planetary gears, and the ring gear are assembled together. A gear structure of the driving screw rod is positioned among the three planetary gears. The tamping sleeve is threadedly connected to the driving screw rod and the tamping sleeve seat, with the tamping plate positioned beneath the tamping sleeve.

### TECHNICAL FIELD

The present disclosure relates to the technical field of coffee machine components, and in particular to a tamping device for a coffee machine.

### BACKGROUND

At present, when brewing high-quality coffee using a pressure coffee machine, the coffee powder needs to be leveled, compacted, evenly compressed, and kept hygienic in advance. Currently, there are devices on the market for tampering coffee powders, and the methods for tampering coffee powders mainly fall into three categories. The first category achieves tampering powder through a vertically moving piston. However, the piston compacts the coffee powders without any rotational movement to evenly distribute coffee powders. This method results in uneven tamping, with some areas being tightly compressed while others remain loose. An example of this method is the Delonghi coffee machine, model “EC9335M”. The second category is equipped with a rotational tamping function. However, the coffee powders grounded must pass through a tamping plate before falling into the filter. This leads to residual coffee powders accumulating on the tamping plate, which are difficult to clean. These residual powders may contaminate the fresh coffee powders in the filter, which is unhygienic. An example of this method is the Breville coffee machine, model “the Oracle Touch”. The third category only has impact tamping function. It cannot level the coffee powders inside the filter before impact tamping. An example of this method is “The Force Tamper”.

Since the existing coffee tamping device has these issues, such as insufficient and uneven tamping, and poor hygiene, it still requires improvements for the prior art.

### SUMMARY

The main objective of the present disclosure is to provide a tamping device for a coffee machine which may solve the technical problems of insufficient and uneven tamping, and poor hygiene in the existing tamping device for the coffee machine.

In order to achieve the objective mentioned above, the present disclosure provides a tamping device for a coffee machine including a tamping handle, a tamping handle connecting block, a screw cap, a pressing wheel, a driven wheel, a plurality of planetary gears, a gear ring, a gear ring cover, a driving screw rod, a pressing ring, a tamping sleeve, a tamping sleeve seat, a tamping plate and a tamping sleeve housing. The tamping handle is screwed at a tail end of the pressing wheel through the tamping handle connecting block, the pressing wheel is installed on a shaft of the driven wheel, a plurality of springs are installed between the driven wheel and the pressing wheel, and a spring cover is fixed on the pressing wheel to cover the plurality of springs. The driven wheel is installed on a shaft of the tamping sleeve housing, the gear ring is snap-fitted onto the tamping sleeve housing, the plurality of planetary gears are evenly distributed inside the gear ring, and the gear ring cover is screwed to the tamping sleeve housing. The plurality of planetary gears includes three planetary gears, an upper part of the driving screw rod is provided with a gear, the gear is installed among the three planetary gears and held in place by the pressing ring, and the driving screw rod is meshed with the three planetary gears. The tamping plate is screwed beneath the tamping sleeve, the tamping sleeve is fitted onto the tamping sleeve seat, and the tamping sleeve seat is fixed inside the tamping sleeve housing. When the driving screw rod rotates, the tamping sleeve and the tamping plate are driven to move in a helical motion.

In some embodiments, the tamping device for the coffee machine further includes a filter and a brewing handle seat. The brewing handle seat is fixed at an opening of the tamping sleeve housing, the brewing handle seat is provided with a brewing handle, and the filter is installed inside the brewing handle.

In some embodiments, the tamping device for the coffee machine further includes a grinding assembly. A powder outlet of the grinding assembly is connected to a powder inlet of the tamping sleeve housing.

In some embodiments, the filter is located directly below the tamping plate, coffee powders from the grinding assembly fall into the filter by gravity. The driving screw rod, the tamping sleeve seat, the tamping sleeve and the tamping plate form a tamping structure with spiral motion. Under the action of the tamping sleeve seat, the driving screw rod drives the tamping sleeve and the tamping plate to move spirally to level and compact the coffee powder in the filter.

In some embodiments, the pressing wheel is provided with a sleeve, the tamping handle connecting block is snap-fitted into the sleeve of the pressing wheel.

In some embodiments, the plurality of springs includes four springs evenly distributed between the pressing wheel and the driven wheel, the plurality of springs are covered by the spring cover, the spring cover is screwed to the pressing wheel. The pressing wheel and the driven wheel are rotatably installed onto a shaft extending out of an outer wall of the tamping sleeve housing through a washer. When the tamping handle rotates under an external force, the pressing wheel is driven by the tamping handle to rotate, thereby driving the driven wheel to rotate through the plurality of springs.

In some embodiments, one end of the driven wheel has a sleeve structure, an other end of the driven wheel has a bevel gear structure, an outer surface of the gear ring has a bevel gear structure, and an inner surface of the gear ring has a spur gear structure installed on the tamping sleeve housing. The driven wheel is meshed with the gear ring through the bevel gear structure of the driven wheel and the bevel gear structure of the gear ring, and the driven wheel rotates to drive the gear ring to rotate.

In some embodiments, the three planetary gears are evenly distributed inside and meshed with the gear ring, the three planetary gears and the gear ring are covered by the gear ring cover, the gear ring rotates to drive the three planetary gears to rotate, and the three planetary gears rotate to drive the driving screw rod through a gear structure of the driving screw rod.

When the coffee powder in the filter is loose, the resistance from the coffee powder to the tamping plate is small, and the pressing wheel and the driven wheel rotate synchronously; when the coffee powder in the filter is compacted, the resistance from the coffee powder to the tamping plate is large, and the driven wheel stops rotating. At this time, the pressing wheel overcomes the elastic force of the springs and continues to rotate a certain angle until it encounters the limiting structure of the driven wheel and stops rotating.

In some embodiments, the driving screw rod has an external thread structure, the tamping sleeve has a dual-thread structure, with thread structures on both an inner wall of the tamping sleeve and an outer wall of the tamping sleeve, and the tamping sleeve seat has an internal thread structure.

In some embodiments, the filter is located directly below the tamping plate, coffee powders from the grinding assembly laterally enter the tamping sleeve housing and fall into the filter by gravity.

In some embodiments, a silicone member is installed in a groove on an outer ring of the tamping sleeve to prevent coffee powders from entering the tamping sleeve, and a sealing silicone is placed between the tamping sleeve and the filter to seal coffee powders inside the filter.

In some embodiments, the tamping device for the coffee machine further includes a reset detection switch for detecting whether the tamping plate has returned to an upper position of the tamping sleeve housing after having finished tamping. The reset detection switch is installed on the tamping sleeve housing and is pressed by the driven wheel when the tamping plate is in the upper position.

Beneficial effect: the present disclosure integrates both distribution and tamping functions, addressing the issue of uneven tamping of coffee powders while enhancing tamping density. With a compact structure and simple operations, it improves upon traditional tamping methods that rely solely on vertical movement.

### BRIEF DESCRIPTION OF DRAWINGS

FIG. 1 is a schematic view of a tamping device for a coffee machine before tamping according to the present disclosure;

FIG. 2 is a schematic view of the tamping device for the coffee machine during grinding according to the present disclosure;

FIG. 3 is a schematic view of the tamping device for the coffee machine during rotational tamping according to the present disclosure;

FIG. 4 is an exploded view of the tamping device for the coffee machine according to the present disclosure;

FIG. 5 is a schematic view of planetary gears layout according to the present disclosure;

FIG. 6 is an exploded view of a pressing wheel, a driven wheel, springs, and a spring cover according to the present disclosure;

FIG. 7 is an assembly view of the pressing wheel, the driven wheel, the springs, and the spring cover according to the present disclosure; and

FIG. 8 is a schematic view of a reset detection switch of a tamping handle according to the present disclosure.

### DESCRIPTION OF EMBODIMENTS

To clarify the purpose, technical solution, and advantages of this present disclosure more clearly and explicitly, the following provides a detailed description of the present disclosure with reference to the accompanying drawings and exemplary embodiments.

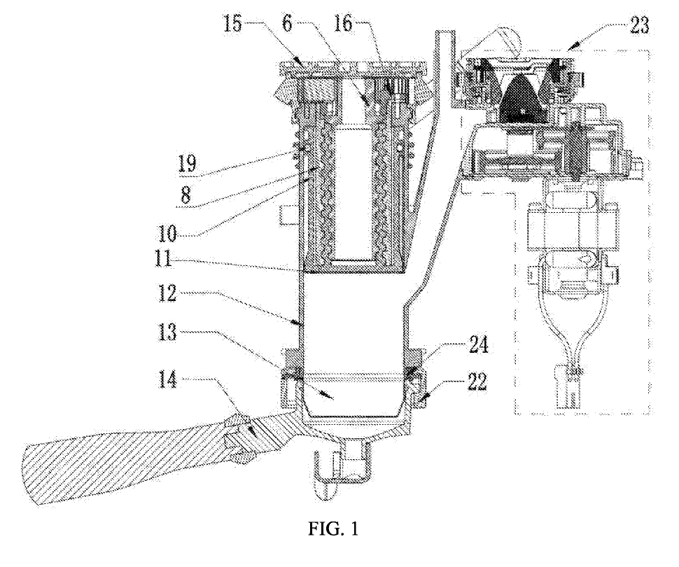

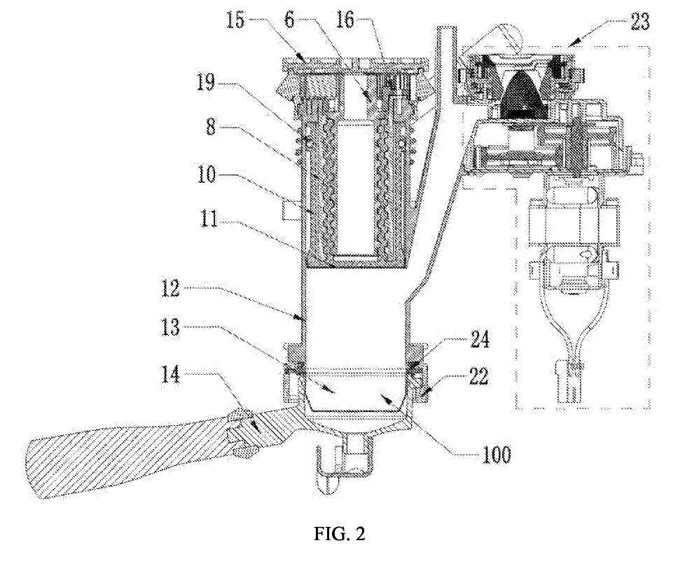

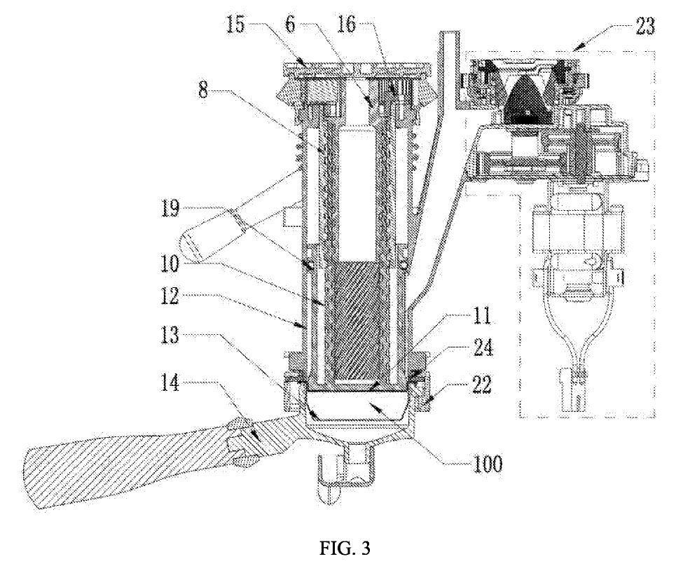

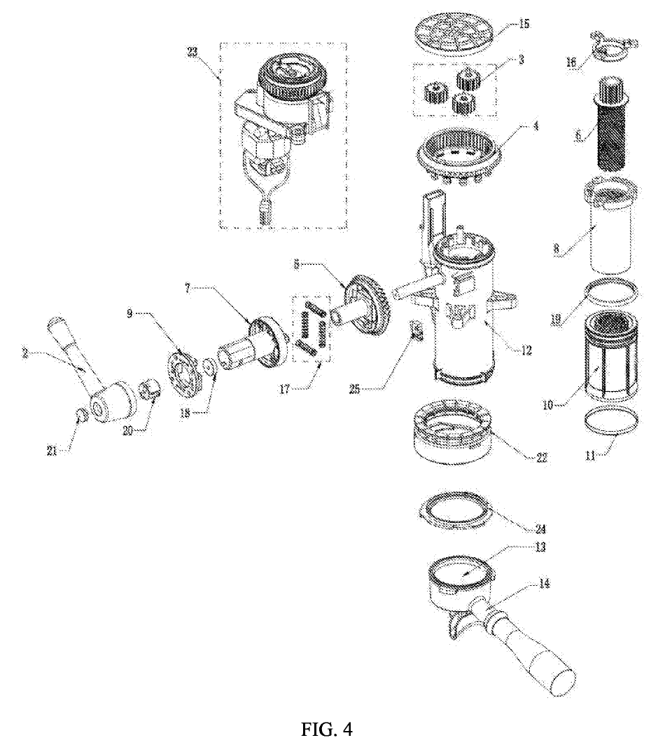

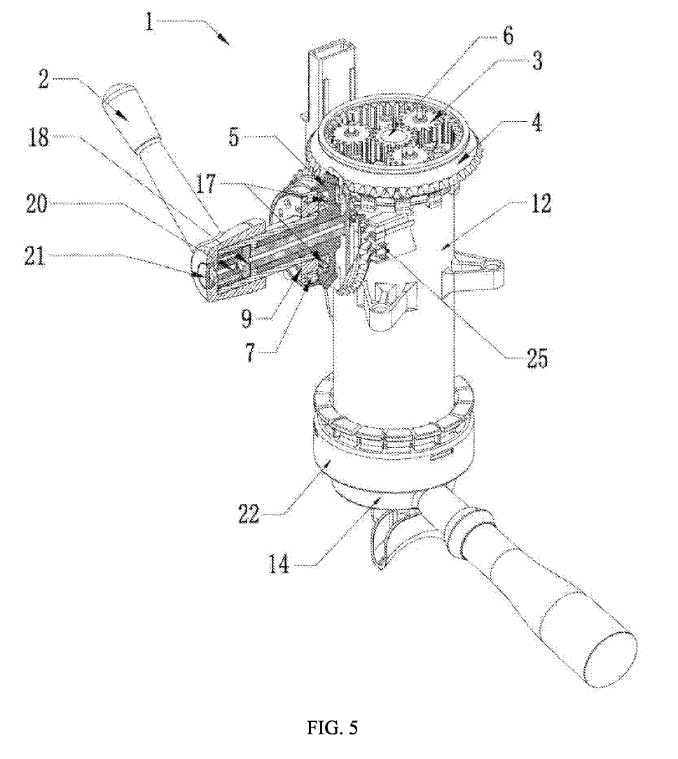

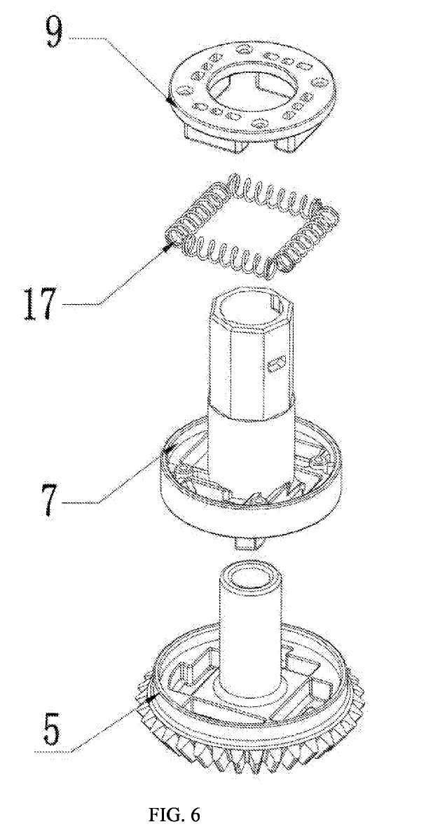

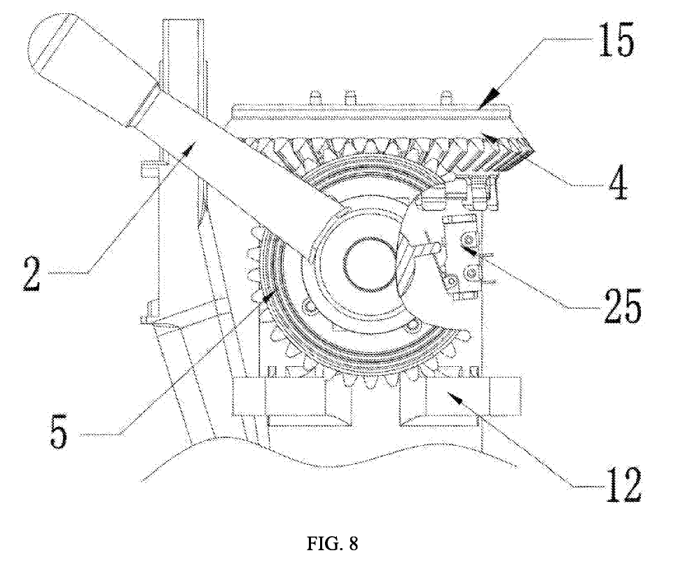

As shown in FIGS. 1-8, this present disclosure provides a tamping device for a coffee machine 1, which includes a tamping handle 2, a tamping handle connecting block 20, a screw cap 21, a pressing wheel 7, a driven wheel 5, a plurality of planetary gears 3, a gear ring 4, a gear ring cover 15, a driving screw rod 6, a pressing ring 16, a tamping sleeve 10, a tamping sleeve seat 8, a tamping plate 11 and a tamping sleeve housing 12. The tamping handle 2 is screwed at a tail end of the pressing wheel 7 through the tamping handle connecting block 20. The pressing wheel 7 is installed on a shaft of the driven wheel 5. A plurality of springs 17 are installed between the driven wheel 5 and the pressing wheel 7, and a spring cover 9 is fixed on the pressing wheel 7 to cover the springs 17. The driven wheel 5 is installed on a shaft of the tamping sleeve housing 12, the gear ring 4 is snap-fitted onto the tamping sleeve housing 12, and the plurality of planetary gears 3 are evenly distributed inside the gear ring 4. The gear ring cover 15 is screwed to the tamping sleeve housing 12. The tamping device includes three planetary gears, an upper part of the driving screw rod 6 is provided with a gear, the gear is installed among the three planetary gears 3 and held in place by the pressing ring 16, and the driving screw rod 6 is meshed with the three planetary gears 3. The tamping plate 11 is screwed beneath the tamping sleeve 10, the tamping sleeve 10 is fitted onto the tamping sleeve seat 8, and the tamping sleeve seat 8 is fixed inside the tamping sleeve housing 12. When the driving screw rod 6 rotates, the tamping sleeve 10 and the tamping plate 11 are driven to move in a helical motion.

With the above structure, the pressing wheel 7 is driven to rotate through the tamping handle 2. The pressing wheel 7 drives the driven wheel 5 to rotate through the springs 17, which in turn drives the gear ring 4. The gear ring 4 drives the planetary gears 3 to rotate, and the planetary gears then drive the driving screw rod 6 to rotate. Under the guidance of the tamping sleeve seat 8, the driving screw rod 6 drives the tamping sleeve 10 and the tamping plate 11 in a helical motion. As the tamping plate 11 moves downward helically, it levels and compacts the coffee powder inside the filter 13. This present disclosure integrates both powder distribution and tamping functions, solving the issue of uneven tamping of the coffee powder while improving the overall tamping density of the coffee powder.

Since the tamping plate 11 is fixed beneath the tamping sleeve 10 with screws, the rotation of the driving screw rod 6 drives the tamping sleeve 10 and the tamping plate 11 in a helical motion. The coffee powder to be tamped is placed inside the filter 13, located beneath the tamping plate 11. The helical motion of the tamping plate 11 levels and compacts the coffee powder.

During the tamping process, rotating the tamping handle 2 clockwise causes the tamping handle 2 to drive the pressing wheel 7 and the driven wheel 5 to rotate in the same direction, which in turn rotates the driving screw rod 6.

Since the tamping sleeve housing 12 encloses the tamping sleeve 10, it provides guidance and positioning for the tamping sleeve 10, ensuring that the movement direction of the tamping plate 11 is vertical, thereby tamping the coffee powder into a flat and even layer.

Preferably, the tamping device also includes a filter 13 and a brewing handle seat 22. The brewing handle seat 22 is fixed at the opening of the tamping sleeve housing 12. The brewing handle seat 22 is also equipped with a brewing handle 14. The filter 13 is installed inside the brewing handle 14 and positioned directly beneath the tamping plate 11 to hold the coffee powder grounded.

Preferably, the tamping device also includes a grinding assembly 23. A powder outlet of the grinding assembly 23 is connected to a powder inlet of the tamping sleeve housing 12. The coffee powder grounded 100 from the grinding assembly 23 falls into the filter 13 through the coffee powder channel of the tamping sleeve housing 12. The coffee powder enters the tamping sleeve housing 12 from the side and falls into the filter 13 under gravity.

Preferably, after the coffee powder falls into the filter 13, the tamping handle 2 is rotated clockwise to begin the tamping process.

The filter 13 is located directly below the tamping plate 11. The coffee powder grounded from the grinding assembly 23 falls into the filter 13 under gravity. The driving screw rod 6, the tamping sleeve seat 8, the tamping sleeve 10, and the tamping plate 11 together form a tamping structure capable of moving helically. Under the guidance of the tamping sleeve seat 8, the driving screw rod 6 drives the tamping sleeve 10 and the tamping plate 11 in a helical motion, leveling and compacting the coffee powder inside the filter 13.

Specifically, when the coffee powder inside the filter 13 is loose, the resistance from the coffee powder to the tamping plate 11 is relatively small, allowing the pressing wheel 7 and the driven wheel 5 to rotate synchronously. When the coffee powder inside the filter 13 is tightly compacted, the resistance from the coffee powder to the tamping plate 11 is relatively large. At this point, the driven wheel 5, the gear ring 4, the planetary gears 3, the driving screw rod 6, and the tamping sleeve 10 stop rotating. The pressing wheel 7 overcomes the spring force of the springs 17 and continues rotating at a certain angle, prompting the user that the coffee powder has been tamped.

Working principle: When the coffee powder inside the filter 13 is loose, the downward helical movement of the tamping plate 11 encounters minimal resistance, allowing the pressing wheel 7 to drive the driven wheel 5 in synchronous rotation. As the tamping plate 11 moves downward, it gradually tamps the coffee powder inside the filter 13. When the tamping level reaches a set value (the required coffee powder density), the resistance exerted by the coffee powder in the filter 13 on the tamping plate 11 increases to a maximum limit. At this point, the tamping plate 11 stops moving downward, and the tamping sleeve 10, the driving screw rod 6, the planetary gears 3, the gear ring 4, and the driven wheel 5 stop rotating. The pressing wheel 7 overcomes the spring force of the springs 17 and rotates independently, creating relative movement with the driven wheel 5. This movement prompts the user that the coffee powder has been properly tamped. Additionally, since the spring force remains nearly constant in each tamping operation, the tamping density of the coffee powder remains consistent.

Specifically, the pressing wheel 7 is provided with a sleeve, and the tamping handle connecting block 20 is snap-fitted into the sleeve of the pressing wheel 7.

Preferably, the plurality of springs 17 includes four springs 17 evenly distributed between the pressing wheel 7 and the driven wheel 5. The plurality of springs 17 are covered by a spring cover 9. The spring cover 9 and the pressing wheel 7 are connected through screws. The pressing wheel 7 and the driven wheel 5 are rotatably installed onto a shaft extending out of an outer wall of the tamping sleeve housing 12 through a washer. When the tamping handle 2 rotates under an external force, the pressing wheel 7 is driven by the tamping handle 2 to rotate, thereby driving the driven wheel 5 to rotate through the springs 17.

Preferably, one end of the driven wheel 5 has a sleeve structure, an other end of the driven wheel 5 has a bevel gear structure, an outer surface of the gear ring 4 has a bevel gear structure, and an inner surface of the gear ring 4 has a spur gear structure installed on the tamping sleeve housing 12. The driven wheel 5 is meshed with the gear ring 4 through the bevel gear structure of the driven wheel 5 and the bevel gear structure of the gear ring 4, and the driven wheel 5 rotates to drive the gear ring 4 to rotate.

Preferably, there are three planetary gears 3. The three planetary gears 3 are evenly distributed inside and meshed with the gear ring 4, the planetary gears 3 and the gear ring 4 are covered by the gear ring cover 15, the gear ring 4 rotates to drive the three planetary gears 3 to rotate, and the plurality of planetary gears 3 rotate to drive the driving screw rod 6 through a gear structure of the driving screw rod 6.

When the coffee powder in the filter 13 is loose, the resistance from the coffee powder to the tamping plate 11 is small, and the pressing wheel 7 and the driven wheel 5 rotate synchronously; when the coffee powder in the filter 13 is compacted, the resistance from the coffee powder to the tamping plate 11 is large, and the driven wheel 5 stops rotating. At this time, the pressing wheel 7 overcomes the elastic force of the springs 17 and continues to rotate a certain angle until it encounters the limiting structure of the driven wheel and stops rotating.

Preferably, the driving screw rod 6 has an external thread structure, the tamping sleeve 10 has a dual-thread structure, with thread structures on both an inner wall of the tamping sleeve 10 and an outer wall of the tamping sleeve 10, and the tamping sleeve seat 8 has an internal thread structure.

Preferably, a silicone member 19 is installed in a groove on an outer ring of the tamping sleeve 10 to prevent coffee powders from entering the tamping sleeve 10, and a sealing silicone 24 is placed between the tamping sleeve 10 and the filter 13 to seal coffee powders inside the filter 13.

Preferably, the tamping sleeve housing 12 is defined with a powder inlet, and the powder inlet of the tamping sleeve housing 12 is connected to a powder outlet of the grinding assembly 23.

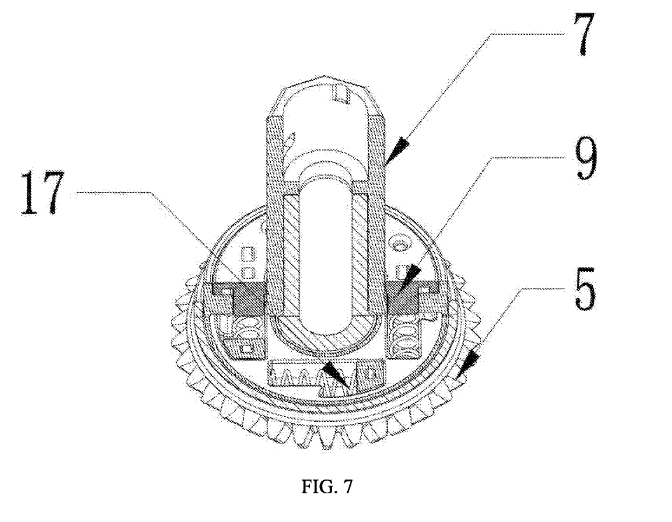

Preferably, as shown in FIG. 7, the tamping device further includes a reset detection switch 25 for detecting whether the tamping plate 11 has returned to an upper position of the tamping sleeve housing 12 after having finished tamping. The reset detection switch 25 is installed on the tamping sleeve housing 12 and is pressed by the driven wheel 5 when the tamping plate 11 is in the upper position. Afterward, the grinding assembly 23 may start grinding beans. At this time, the tamping plate 11 is positioned above the powder outlet, ensuring that the outlet remains unobstructed, allowing the coffee powder grounded to fall into the filter 13.

Preferably, the gear ring 4 is installed on the tamping sleeve housing 12 through a buckle and is capable of rotating around the tamping sleeve housing 12.

Preferably, the tamping device may be manually operated but may also be motor-driven. The motor is engaged with the gear ring 4 through a gear to drive the gear ring 4, the tamping sleeve 10, and the tamping plate 11 to rotate, thereby achieving both powder distribution and tamping.

The tamping device for the coffee machine is used to tamp a specific amount of coffee powders within the filter. It is mainly used for tamping coffee powders in a coffee grinder and a pressure coffee machine with a grinding function, as well as used as a tamping machine and a tamper serving a pressure coffee machine.

The present disclosure has advantages of ingenious design, compact structure, and easy operation. It improves upon the traditional method of tamping powder solely through vertical movement. The traditional method fails to achieve simultaneous powder distribution (leveling the powder) and tamping.

The above description is merely a preferred embodiment of this present disclosure and should not be used to limit its scope of rights. It should be noted that modifications or equivalent replacements of the technical solution of this present disclosure, made by those skilled in the field without requiring creative effort, do not fall outside the protection scope of this present disclosure.

What is claimed is:

1. A tamping device for a coffee machine, comprising a tamping handle, a tamping handle connecting block, a screw cap, a pressing wheel, a driven wheel, a plurality of planetary gears, a gear ring, a gear ring cover, a driving screw rod, a pressing ring, a tamping sleeve, a tamping sleeve seat, a tamping plate and a tamping sleeve housing,
wherein the tamping handle is screwed at a tail end of the pressing wheel through the tamping handle connecting block, the pressing wheel is installed on a shaft of the driven wheel, a plurality of springs are installed between the driven wheel and the pressing wheel, and a spring cover is fixed on the pressing wheel to cover the plurality of springs;
wherein the driven wheel is installed on a shaft of the tamping sleeve housing, the gear ring is snap-fitted onto the tamping sleeve housing, the plurality of planetary gears are evenly distributed inside the gear ring, and the gear ring cover is screwed to the tamping sleeve housing;
wherein the plurality of planetary gears comprises three planetary gears, an upper part of the driving screw rod is provided with a gear, the gear is installed among the three planetary gears and held in place by the pressing ring, and the driving screw rod is meshed with the three planetary gears; and
wherein the tamping plate is screwed beneath the tamping sleeve, the tamping sleeve is fitted onto the tamping sleeve seat, and the tamping sleeve seat is fixed inside the tamping sleeve housing, and wherein when the driving screw rod rotates, the tamping sleeve and the tamping plate are driven to move in a helical motion.

2. The tamping device for the coffee machine according to claim 1, further comprising a filter and a brewing handle seat, wherein the brewing handle seat is fixed at an opening of the tamping sleeve housing, the brewing handle seat is provided with a brewing handle, and the filter is installed inside the brewing handle.

3. The tamping device for the coffee machine according to claim 2, further comprising a grinding assembly, wherein a powder outlet of the grinding assembly is connected to a powder inlet of the tamping sleeve housing.

4. The tamping device for the coffee machine according to claim 1, wherein the pressing wheel is provided with a sleeve, the tamping handle connecting block is snap-fitted into the sleeve of the pressing wheel, and the plurality of springs comprises four springs evenly distributed between the pressing wheel and the driven wheel;
wherein the plurality of springs are covered by the spring cover, the spring cover is screwed to the pressing wheel, and the pressing wheel and the driven wheel are rotatably installed onto a shaft extending out of an outer wall of the tamping sleeve housing through a washer; and
wherein when the tamping handle rotates under an external force, the pressing wheel is driven by the tamping handle to rotate, thereby driving the driven wheel to rotate through the plurality of springs.

5. The tamping device for the coffee machine according to claim 4, wherein one end of the driven wheel has a sleeve structure, an other end of the driven wheel has a bevel gear structure, an outer surface of the gear ring has a bevel gear structure, and an inner surface of the gear ring has a spur gear structure installed on the tamping sleeve housing; and
wherein the driven wheel is meshed with the gear ring through the bevel gear structure of the driven wheel and the bevel gear structure of the gear ring, and the driven wheel rotates to drive the gear ring to rotate.

6. The tamping device for the coffee machine according to claim 4, wherein the three planetary gears are evenly distributed inside and meshed with the gear ring, the three planetary gears and the gear ring are covered by the gear ring cover, the gear ring rotates to drive the three planetary gears to rotate, and the three planetary gears rotate to drive the driving screw rod through a gear structure of the driving screw rod.

7. The tamping device for the coffee machine according to claim 1, wherein the driving screw rod has an external thread structure, the tamping sleeve has a dual-thread structure, with thread structures on both an inner wall of the tamping sleeve and an outer wall of the tamping sleeve, and the tamping sleeve seat has an internal thread structure.

8. The tamping device for the coffee machine according to claim 3, wherein the filter is located directly below the tamping plate, coffee powders from the grinding assembly laterally enter the tamping sleeve housing and fall into the filter by gravity.

9. The tamping device for the coffee machine according to claim 2, wherein a silicone member is installed in a groove on an outer ring of the tamping sleeve to prevent coffee powders from entering the tamping sleeve, and a sealing silicone is placed between the tamping sleeve and the filter to seal coffee powders inside the filter.

10. The tamping device for the coffee machine according to claim 1, further comprising a reset detection switch for detecting whether the tamping plate has returned to an upper position of the tamping sleeve housing after having finished tamping,
wherein the reset detection switch is installed on the tamping sleeve housing and is pressed by the driven wheel when the tamping plate is in the upper position.
